(19) United States
(12) Patent Application Publication
(10) Pub. No.: US 2023/0028758 A1
(43) Pub. Date: Jan. 26, 2023

(54) METHOD OF PRODUCING MEAT-LIKE FOOD PRODUCT

(71) Applicant: J-OIL MILLS, INC., Tokyo (JP)

(72) Inventors: Naoko DODO, Tokyo (JP); Koji SAGARA, Tokyo (JP); Junko ARAI, Tokyo (JP); Miho ABE, Tokyo (JP); Kazuhisa MIZUNO, Tokyo (JP)

(21) Appl. No.: 17/784,717

(22) PCT Filed: Dec. 16, 2020
(86) PCT No.: PCT/JP2020/046926

§ 371 Date: Jun. 13, 2022

(30) Foreign Application Priority Data
Dec. 25, 2019 (JP) 2019-235248

(51) Int. Cl. A23L 29/212; A23J 3/16; A23J 3/18; A23J 3/22; A23L 5/10

(52) U.S. Cl. CPC A23L 29/212; A23J 3/16; A23J 3/18; A23J 3/227; A23L 5/10; A23V 2002/00

(57) ABSTRACT

The method of producing a meat-like food product according to the present invention includes adding a plant-derived protein and a form of granular powder (A) satisfying the conditions (1) to (4) below to food product materials to prepare a dough. The dough contains 0% by mass or more and 30% by mass or less of an animal-derived protein material. (1) The form of granular powder has a starch content of 75% by mass or more; (2) the form of granular powder contains 3% by mass or more and 45% by mass or less of a molecular weight-reduced starch of a starch having an amylose content of 5% by mass or more, the molecular weight-reduced starch having a peak molecular weight of 3×10³ or more and 5×10⁴ or less; (3) the form of granular powder has a degree of swelling in cold water at 25° C. of 5 or more and 20 or less; and (4) the content of matters under a sieve having an opening of 3.35 mm and on a sieve having an opening of 0.038 mm is 50% by mass or more and 100% by mass or less.

### TECHNICAL FIELD

The present invention relates to a method of producing a meat-like food product.

### BACKGROUND ART

Recently, people who avoid food products containing animal-derived ingredients have been increasing for a variety of reasons such as health reasons such as allergy and diseases, their principles, environmental reasons, and religious and spiritual reasons. Furthermore, accompanied by a world-wide increase in population, concerns about a shortage of meat supply in the future are also pointed out. In such circumstance, meat-like food products including plant-derived proteins receive attention.

However, unlike meat products such as minced meat, plant-derived proteins do not become viscous even if kneaded, which leads to a demerit of plant-derived proteins that these are difficult to form doughs such as soy burger patties. For this reason, a paste of mashed potato or beans, egg white, wheat flour, and/or starch need to be used as a binder. However, meat-like food products thus prepared are sticky, chewy, and difficult to provide feelings of natural disentanglement when cattle meat is used.

PTL 1 discloses a burger patty-like food product for people having swallowing difficulties, the food product providing a certain feel of meat granules by adding starch to an emulsion prepared with predetermined amounts of tissue-like soybean protein and separate soybean protein.

PTL 2 discloses production of a meat-like food product having high performance in texture and the like with a combination of an oil coated starch with a soybean protein material and further an optional additional protein material.

This production method can provide an inexpensive meat-like food product having a reduced glue-like taste derived from starch.

### CITATION LIST

### Patent Literature

PTL 1: Japanese Unexamined Patent Application Publication No. 2016-67250

PTL 2: Japanese Patent No. 6565013

### SUMMARY OF INVENTION

### Technical Problem

However, while the methods according to PTLs 1 and 2 each provide certain texture modification effects, these are still susceptible to improvement in reduction in stickiness and increase in chewability and disentanglement properties.

### Solution to Problem

Thus, the present inventors have conducted extensive research to find that a meat-like food product having reduced stickiness, improved chewability, and improved disentanglement properties is obtained by adding a specific ingredient to a meat-like food product containing a plant-derived protein, thereby completing the present invention.

In other words, the present invention provides the following method of producing a meat-like food product, the following dough of a meat-like food product, the following texture improver for a meat-like food product, a method of reducing stickiness of a meat-like food product, and a method of improving disentanglement properties of a meat-like food product. [1] A method of producing a meat-like food product, including adding a plant-derived protein and an ingredient (A) to food product materials to prepare a dough, in which the dough contains 0% by mass or more and 30% by mass or less of an animal-derived protein material, and the ingredient (A) is a form of granular powder satisfying the conditions (1) to (4):
(1) the form of granular powder has a starch content of 75% by mass or more, (2) the form of granular powder contains 3% by mass or more and 45% by mass or less of a molecular weight-reduced starch of a starch having an amylose content of 5% by mass or more, the molecular weight-reduced starch having a peak molecular weight of 3×10³ or more and 5×10⁴ or less,
(3) the form of granular powder has a degree of swelling in cold water at 25° C. of 5 or more and 20 or less, and
(4) the content of matters under a sieve having an opening of 3.35 mm and on a sieve having an opening of 0.038 mm is 50% by mass or more and 100% by mass or less. [2] The production method according to [1], in which the amount of the ingredient (A) added to the dough is 0.3% by mass or more and 10% by mass or less. [3] The production method according to [1] or [2], in which the plant-derived protein is derived from one or two or more selected from the group consisting of soybean, pea, and wheat.

[4] The production method according to any one of [1] to [3], in which the plant-derived protein is a separated and refined protein. [5] The production method according to any one of [1] to [4], in which the dough contains 0% by mass of the animal-derived protein material. [6] The production method according to any one of [1] to [5], in which the ingredient (A) has a content of matters under a sieve having an opening of 0.5 mm and on a sieve having an opening of 0.075 mm of 25% by mass or more and 100% by mass or less. [7] The production method according to any one of [1] to [6], further including cooking the dough by heating.

[8] A dough of a meat-like food product including a plant-derived protein, food product materials, and an ingredient (A), in which the dough contains 0% by mass or more and 30% by mass or less of an animal-derived protein material, and the ingredient (A) is a form of granular powder satisfying the conditions (1) to (4):

(1) the form of granular powder has a starch content of 75% by mass or more,

(2) the form of granular powder contains 3% by mass or more and 45% by mass or less of a molecular weight-reduced starch of a starch having an amylose content of 5% by mass or more, the molecular weight-reduced starch having a peak molecular weight of 3×10³ or more and 5×10⁴ or less,

(3) the form of granular powder has a degree of swelling in cold water at 25° C. of 5 or more and 20 or less, and

(4) the content of matters under a sieve having an opening of 3.35 mm and on a sieve having an opening of 0.038 mm is 50% by mass or more and 100% by mass or less. [9] A texture improver for a meat-like food product, including an ingredient (A) as an active ingredient, in which a dough of the meat-like food product contains a plant-derived protein, and contains 0% by mass or more and 30% by mass or less of an animal-derived protein material, and the ingredient (A) is a form of granular powder satisfying the conditions (1) to (4):
(1) the form of granular powder has a starch content of 75% by mass or more, (2) the form of granular powder contains 3% by mass or more and 45% by mass or less of a molecular weight-reduced starch of a starch having an amylose content of 5% by mass or more, the molecular weight-reduced starch having a peak molecular weight of 3×10³ or more and 5×10⁴ or less,
(3) the form of granular powder has a degree of swelling in cold water at 25° C. of 5 or more and 20 or less, and
(4) the content of matters under a sieve having an opening of 3.35 mm and on a sieve having an opening of 0.038 mm is 50% by mass or more and 100% by mass or less. [10] A method of reducing stickiness of a meat-like food product prepared by cooking a dough containing a plant-derived protein by heating, in which the dough contains 0% by mass or more and 30% by mass or less of an animal-derived protein material, the method including adding an ingredient (A) to the dough, in which the ingredient (A) is a form of granular powder satisfying the conditions (1) to (4):

(1) the form of granular powder has a starch content of 75% by mass or more,

(2) the form of granular powder contains 3% by mass or more and 45% by mass or less of a molecular weight-reduced starch of a starch having an amylose content of 5% by mass or more, the molecular weight-reduced starch having a peak molecular weight of 3×10³ or more and 5×10⁴ or less,

(3) the form of granular powder has a degree of swelling in cold water at 25° C. of 5 or more and 20 or less, and

(4) the content of matters under a sieve having an opening of 3.35 mm and on a sieve having an opening of 0.038 mm is 50% by mass or more and 100% by mass or less. [11] A method of improving disentanglement properties of a meat-like food product prepared by cooking a dough containing a plant-derived protein by heating, in which the dough contains 0% by mass or more and 30% by mass or less of an animal-derived protein material, the method including adding an ingredient (A) to the dough, in which the ingredient (A) is a form of granular powder satisfying the conditions (1) to (4):
(1) the form of granular powder has a starch content of 75% by mass or more, (2) the form of granular powder contains 3% by mass or more and 45% by mass or less of a molecular weight-reduced starch of a starch having an amylose content of 5% by mass or more, the molecular weight-reduced starch having a peak molecular weight of 3×10³ or more and 5×10⁴ or less,
(3) the form of granular powder has a degree of swelling in cold water at 25° C. of 5 or more and 20 or less, and
(4) the content of matters under a sieve having an opening of 3.35 mm and on a sieve having an opening of 0.038 mm is 50% by mass or more and 100% by mass or less.

It is to be noted that any combination of these configurations and expressions of the present invention converted into methods or apparatuses are also effective as aspects according to the present invention.

### Advantageous Effects of Invention

The present invention can provide a meat-like food product having reduced stickiness, improved chewability, and improved disentanglement properties.

The term “stickiness” used here indicates the state where a food product, when chewed, is mixed with saliva in the mouth and becomes sticky. The term “disentanglement properties” used here indicates the state where a food product is naturally broken into pieces like heated minced meat immediately when the food product is chewed, and indicates a texture different from that of the food product mashed with teeth.

### DESCRIPTION OF EMBODIMENTS

Hereinafter, embodiments according to the present invention will be described by way of specific examples of ingredients. These ingredients can each be used alone or in combination.

In the present embodiment, the method of producing a meat-like food product includes mixing a plant-derived protein and an ingredient (A) with food product materials to prepare a dough, in which the dough contains 0% by mass or more and 30% by mass or less of an animal-derived protein material, and the ingredient (A) is a form of granular powder satisfying the conditions (1) to (4):
(1) the form of granular powder has a starch content of 75% by mass or more,
(2) the form of granular powder contains 3% by mass or more and 45% by mass or less of a molecular weight-reduced starch of a starch having an amylose content of 5% by mass or more, the molecular weight-reduced starch having a peak molecular weight of 3×10³ or more and 5×10⁴ or less,
(3) the form of granular powder has a degree of swelling in cold water at 25° C. of 5 or more and 20 or less, and
(4) the content of matters under a sieve having an opening of 3.35 mm and on a sieve having an opening of 0.038 mm is 50% by mass or more and 100% by mass or less.

Hereinafter, the meat-like food product and ingredients, i.e., raw materials for the meat-like food product will be specifically described.

### (Meat-Like Food Product)

The meat-like food product according to the present invention is a food product containing a plant-derived protein as the main protein and a flavor and texture similar to those of a cattle meat-processed food product. Here, the cattle meat-processed food product indicates a food product which is composed of a cattle meat material such as minced or diced meat as the main raw material, and prepared by mixing with optional raw materials such as vegetables, cereal flour, egg, and seasonings, and forming the mixture, followed by cooking by heating, and examples thereof include hamburger patties, minced meat cutlets, meat loaves, stuffed cabbages, nuggets, sausages, meat balls, chicken meat balls, and fillings for dumplings, shao mai, and steamed meat buns.

### (Plant-Derived Protein)

The method of producing a meat-like food product according to the present embodiment includes a plant-derived protein. Examples of sources for the plant-derived protein include beans such as soybean, pea, and broad bean; cereals such as wheat, rice, and corn; potatoes; and nuts. To improve the disentanglement properties, preferred are one or two or more selected from the group consisting of beans and cereals, more preferred are one or two or more selected from the group consisting of soybean, pea, wheat, and corn, still more preferred are one or two or more selected from the group consisting of soybean, pea, and wheat, further still more preferred are one or two or more selected from the group consisting of soybean and pea, and most preferred is soybean.

Although the plant-derived protein includes unrefined proteins such as protein contained in boiled beans, the plant-derived protein preferably contains a separated and refined protein separated from a plant and refined. Examples of the separated and refined protein include those containing 40% by mass or more of protein in terms of dry mass. If the separated and refined protein is contained, several separated and refined proteins having a particle size adjusted if necessary may be combined. Alternatively, an unrefined protein may be used in combination with a refined protein.

### (Animal-Derived Protein Material)

Examples of the animal-derived protein material in the method of producing a meat-like food product according to the present invention include meats of cows, pigs, sheep, horses, frogs, chickens, domestic ducks, wild ducks, hybrids of domestic ducks and wild ducks, Japanese quails, and wild turkeys; seafoods such as fish, mollusks, and shellfish; proteins derived from arthropods such shrimps, crabs, Japanese mantis shrimp, and insects; cultivated meats; eggs including whole eggs, egg yellow, egg white, and dry powders thereof; and dairy products such as milk, defatted milk, whey (milk serum), dry powders thereof, cheese, and casein.

Examples of forms of the animal-derived protein include a minced form, a diced form, a mashed form, and a form of flakes. Preferred is a minced form. The method of producing a meat-like food product according to the present invention can provide a meat-like food product having a flavor and texture similar to those of the cattle meat-processed food product even with a smaller amount of the animal-derived protein material added.

In consideration of social needs to avoid the animal-derived protein for a variety of reasons, the amount of the animal-derived protein material added to the method of producing a meat-like food product according to the present invention is 30% by mass or less, preferably 20% by mass or less, more preferably 15% by mass or less, still more preferably 10% by mass or less, further still more preferably 5% by mass or less in the dough of the meat-like food product.

From the same viewpoint as above, the content of the animal-derived protein material in the dough of the meat-like food product is 0% by mass or more, and may be 1% by mass or more. Preferably, the content of the animal-derived protein material is 0% by mass.

### (Ingredient (A))

The ingredient (A) is a form of granular powder containing 75% by mass or more of starch. Here, the form of granular powder indicates a product containing at least one of a powdery product and a granular product, and may be a product containing both a powdery product and a granular product.

As a starch, the ingredient (A) contains 3% by mass or more and 45% by mass or less of a molecular weight-reduced starch in the form of granular powder, the molecular weight-reduced starch being formed from a starch having an amylose content of 5% by mass or more and having a peak molecular weight of 3×10³ or more and 5×10⁴ or less. The degree of swelling in cold water at 25° C. is 5 or more and 20 or less. Furthermore, the ingredient (A) has a content of matters under a sieve having an opening of 3.35 mm and on a sieve having an opening of 0.038 mm of 50% by mass or more and 100% by mass or less.

Hereinafter, the ingredient (A) will be more specifically described.

To reduce stickiness and improve chewability and disentanglement properties, the content of the starch in the ingredient (A) is preferably 80% by mass or more, more preferably 85% by mass or more.

Although the upper limit of the starch content of matters of the ingredient (A) is not limited and is 100% by mass or less, the content may be 99.5% by mass or less or 99% by mass or less, for example, depending on the properties of the meat-like food product.

As the starch, the ingredient (A) contains a molecular weight-reduced starch in a specific proportion, the molecular weight-reduced starch being formed from a starch having an amylose content of 5% by mass or more as a raw material. The molecular weight-reduced starch to be used has a specific peak molecular weight. In other words, the starch in the ingredient (A) contains 3% by mass or more and 45% by mass or less of a molecular weight-reduced starch in the ingredient (A), the molecular weight-reduced starch being formed from a starch having an amylose content of 5% by mass or more as a raw material and having a peak molecular weight of 3×10³ or more and 5×10⁴ or less.

To reduce stickiness and improve chewability and disentanglement properties, the molecular weight-reduced starch has a peak molecular weight of 3 X 10³ or more, preferably 8×10³ or more. From the same viewpoint as above, the molecular weight-reduced starch has a peak molecular weight of 5×10⁴ or less, preferably 3×10⁴ or less, more preferably 1.5×10⁴ or less. The method of measuring the peak molecular weight of the starch after decomposition will be described in Examples.

From the viewpoint of high production stability, the molecular weight-reduced starch is preferably one or two or more selected from the group consisting of acid treated starches, oxidized starches, and enzyme treated starches, more preferably acid treated starches.

The condition for the acid treatment is particularly not limited, and the acid treatment can be performed as follows, for example.

A starch having an amylose content of 5% by mass or more and water are placed into a reactor, and an acid is further placed thereinto. Alternatively, an acid water prepared by preliminarily dissolving an acid in water and a starch as a raw material are placed into a reactor. To stably perform the acid treatment, it is desired that the total amount of the starch during the reaction is homogeneously dispersed in an aqueous phase or formed into a slurry. For this, the concentration of the starch slurry when the acid treatment is performed is adjusted to in the range of, for example, 10% by mass or more and 50% by mass or less, preferably 20% by mass or more and 40% by mass or less. A significantly high slurry concentration may increase the slurry viscosity, leading to difficulties in homogeneous stirring of the slurry in some cases.

Examples of an acid used in the acid treatment specifically include inorganic acids such as hydrochloric acid, sulfuric acid, and nitric acid. Any of these can be used with any purity.

In the acid treatment reaction, for example, the acid concentration during the acid treatment is preferably 0.05N (normality) or more and 4 N or less, more preferably 0.1 N or more and 4 N or less, still more preferably 0.2N or more and 3 N or less. The reaction temperature is preferably 30° C. or more and 70° C. or less, more preferably 35° C. or more and 70° C. or less, still more preferably 35° C. or more and 65° C. or less. The reaction time is preferably 0.5 hours or more and 120 hours or less, more preferably 1 hour or more and 72 hours or less, still more preferably 1 hour or more and 48 hours or less.

To reduce stickiness and improve chewability and disentanglement properties, the content of the molecular weight-reduced starch in the ingredient (A) is 3% by mass or more, preferably 8% by mass or more, more preferably 13% by mass or more relative to the total amount of the ingredient (A).

On the other hand, from the same viewpoint as above, the content of the molecular weight-reduced starch in the ingredient (A) is 45% by mass or less, preferably 35% by mass or less, more preferably 25% by mass or less relative to the total amount of the ingredient (A).

The amylose content of the raw material starch for the molecular weight-reduced starch is 5% by mass or more, preferably 12% by mass or more, more preferably 22% by mass or more, still more preferably 45% by mass or more, further still more preferably 55% by mass or more, most preferably 65% by mass or more. The upper limit of the amylose content the raw material starch for the molecular weight-reduced starch is not limited, and is 100% by mass or less, preferably 90% by mass or less, more preferably 80% by mass or less.

As the starch having an amylose content of 5% by mass or more as the raw material for the molecular weight-reduced starch, one or two or more selected from the group consisting of high-amylose corn starch, corn starch, tapioca starch, sweet potato starch, potato starch, wheat starch, high-amylose wheat starch, rice starch, and processed starches prepared by chemically, physically, or enzymatically processing these raw materials can be used. To reduce stickiness and improve melt in the mouth, preferred is use of one or two or more selected from the group consisting of high-amylose corn starch, corn starch, and tapioca starch, and more preferred is use of high-amylose corn starch. High-amylose corn starches having an amylose content of 40% by mass or more are available. The starch having an amylose content of 5% by mass or more is more preferably a corn starch having an amylose content of 40% by mass or more.

To reduce stickiness and improve chewability and disentanglement properties, the degree of swelling in cold water at 25° C. of the ingredient (A) is 5 or more, preferably 5.5 or more, still more preferably 6 or more.

From the same viewpoint as above, the degree of swelling in cold water at 25° C. of the ingredient (A) is 20 or less, preferably 17 or less, more preferably 15 or less, still more preferably 13 or less.

Here, the degree of swelling in cold water at 25° C. of the ingredient (A) is measured by the following method.
(1) Using an aquameter (available from KENSEI KOGYO Co., Ltd., Type No.

MX-50), a sample is dried by heating at 125° C. to measure the moisture content, and the dry mass thereof is calculated from the measured moisture content.
(2) 1 g of the sample in terms of the dry mass is dispersed in 50 mL of water at 25° C., and is mildly stirred for 30 minutes in a thermostat at 25° C. Thereafter, the mixture is centrifuged at 3000 rpm for 10 minutes (centrifuge: available from Hitachi Koki Co., Ltd., Hitachi Desktop Centrifuge CT6E type; rotor: T4SS swing rotor; adapter: 50TC x 2S adapter, and a precipitant layer is separated from a supernatant layer.
(3) The supernatant layer is removed, and the mass of the precipitant layer is measured. This is defined as B (g).
(4) The mass of the precipitant layer dried into solid (105° C., constant mass) is defined as C (g).
(5) The value obtained by dividing B by C is defined as the degree of swelling in cold water.

To improve the disentanglement properties, the ingredient (A) has a content of matters under a sieve having an opening of 3.35 mm and on a sieve having an opening of 0.038 mm according to the JIS-Z8801-1 standard of 50% by mass or more, preferably 55% by mass, more preferably 60% by mass or more, still more preferably 65% by mass or more, further still more preferably 70% by mass or more.

To reduce stickiness and improve chewability, the ingredient (A) has a content of matters under a sieve having an opening of 3.35 mm and on a sieve having an opening of 0.038 mm according to the JIS-Z8801-1 standard of 100% by mass or less, and may be 99% by mass or less.

To reduce stickiness and improve chewability, the ingredient (A) has a content of matters under a sieve having an opening of 0.5 mm and on a sieve having an opening 0.075 mm according to the JIS-Z8801-1 standard of preferably 25% by mass or more, more preferably 35% by mass or more, still more preferably 50% by mass or more, further still more preferably 60% by mass or more.

To reduce stickiness and improve chewability, the ingredient (A) has a content of matters under a sieve having an opening of 0.5 mm and on a sieve having an opening 0.075 mm according to the JIS-Z8801-1 standard of preferably 100% by mass or less, more preferably 95% by mass or less, still more preferably 90% by mass or less, further still more preferably 85% by mass or less.

To improve disentanglement properties, the ingredient (A) has a content of matters under a sieve having an opening of 0.5 mm and on a sieve having an opening 0.075 mm according to the JIS-Z8801-1 standard of preferably 25% by mass or more, more preferably 35% by mass or more.

To improve disentanglement properties, the ingredient (A) has a content of matters under a sieve having an opening of 0.5 mm and on a sieve having an opening of 0.075 mm according to the JIS-Z8801-1 standard of preferably 100% by mass or less, more preferably 90% by mass or less, still more preferably 85% by mass or less, further still more preferably 70% by mass or less, most preferably 60% by mass or less.

In the present embodiment, a variety of starches can be used as a starch ingredient other than the molecular weight-reduced starch in the ingredient (A). Specifically, any usual starch commercially available according to applications, for example, any starch for food products can be used, and one or more can be appropriately selected from starches such as corn starch, potato starch, tapioca starch, and wheat starch and processed starches thereof prepared by chemically, physically, or enzymatically processing these starches. Preferably, one or two or more starches selected from the group consisting of corn starch, wheat starch, potato starch, tapioca starch, and cross-linked starches thereof are contained, and more preferably, corn starch is contained.

The ingredient (A) according to the present embodiment can also contain ingredients other than the starch.

Specific examples of the ingredients other than the starch include insoluble salts such as calcium carbonate and calcium sulfate, and dyes. An insoluble salt is preferably added. More preferably, the amount of the insoluble salt added is 0.1% by mass or more and 2% by mass or less.

Next, the method of producing the ingredient (A) will be described. For example, the method of producing the ingredient (A) includes the following steps:

(Preparation of molecular weight-reduced starch) degrading a raw material starch having an amylose content of 5% by mass or more to prepare a molecular weight-reduced starch having a peak molecular weight of 3×10³ or more and 5×10⁴ or less; and

(Granulation) gelatinizing a raw material by heating, followed by granulation, the raw material containing 3% by mass or more and 45% by mass or less of the molecular weight-reduced starch where the total content of the molecular weight-reduced starch and a starch other than the molecular weight-reduced starch is 75% by mass or more.

The preparation of the molecular weight-reduced starch is a step of decomposing a starch having an amylose content of 5% by mass or more into a molecular weight-reduced starch. The term “decomposition” used here indicates decomposition accompanied by degradation of the starch, and examples of typical decomposition methods include decomposition by an acid treatment, an oxidation treatment, and an enzyme treatment. Among these, preferred is an acid treatment from the viewpoint of the decomposition rate, cost, and the reproductivity of the decomposition reaction.

The granulation can be performed by a standard method used in granulation of starch. To provide a predetermined degree of swelling in cold water, preferred is use of a standard method used in gelatinization of starch by heating. Specifically, methods using a machine such as a drum dryer, a jet cooker, an extruder, or a spray dryer are known. In the present embodiment, to ensure preparation of the ingredient (A) having a degree of swelling in cold water satisfying the above-mentioned specific condition, preferred is gelatinization with an extruder or a drum dryer, and more preferred is gelatinization with an extruder.

In a treatment with an extruder, usually, water is added to the raw material containing the starch to adjust the moisture content to about 10 to 60% by mass, and the raw material is swollen by heating at a barrel temperature of 30 to 200° C., an outlet temperature of 80 to 180° C., a screw number of rotations of 100 to 1,000 rpm for a heat treatment time of 5 to 60 seconds.

In the present embodiment, an ingredient (A) having a degree of swelling in cold water satisfying the specific condition can be prepared through gelatinization of the specific raw material by heating. The granulated product through gelatinization by heating may be optionally grounded, and be sieved to appropriately adjust the size, thus preparing the ingredient (A).

The ingredient (A) prepared as above is a form of granular powder containing the molecular weight-reduced starch, and satisfies the specific conditions of the starch content, the degree of swelling in cold water, and the peak molecular weight of the molecular weight-reduced starch, and thus can reduce the stickiness of the resulting meat-like food product and improve the chewability and the disentanglement properties thereof.

To reduce the stickiness and improve the disentanglement properties, the content of the ingredient (A) in the dough of the meat-like food product according to the present invention is preferably 0.3% by mass or more, more preferably 1.3% by mass or more, still more preferably 2.5% by mass or more, further still more preferably 3.3% by mass or more, most preferably 4.5% by mass or more.

From the same viewpoint as above, the content of the ingredient (A) in the dough of the meat-like food product according to the present invention is preferably 10% by mass or less, more preferably 9% by mass or less, still more preferably 8% by mass or less.

### (Food Product Materials)

Next, food product materials according to the present invention will be described. The food product materials are raw materials added when a dough of the meat-like food product is prepared. To be noted, the above-mentioned plant-derived protein, animal-derived protein material, and ingredient (A) are excluded from the food product materials.

The food product materials can be any food product materials usually used in food products. Specific examples thereof include cereals such as rice, whole grain rice, wheat, barley, corn, sesame, proso millet, foxtail millet, cereal flours thereof, and processed products thereof (excluding the proteins separated therefrom and refined); vegetables; fruits; saccharides such as minced products thereof and pastes thereof; sugars such as sugar, fructose, glucose, honey, high-fructose corn syrup, invert sugar, oligosaccharide, dextrin, trehalose, and sugar alcohol; sweeteners such as aspartame and acesulfame potassium; starches and starch compositions other than the ingredient (A); dietary fibers such as bran, cellulose, and resistant dextrin; chemical leavening agents such as baking powder; edible oils and fats such as margarine, shortening, rapeseed oil, and soybean oil; polysaccharide thickeners such as guar gum and alginic acid esters; emulsifiers; fragrances; and seasonings such as diet salt, sake, broth, and monosodium glutamate.

The dough of the meat-like food product preferably contains a cereal flour as a food product material, more preferably contains one or two or more selected from wheat flour and starches.

### (Methods of Preparing Meat-Like Food Product and Dough of Meat-Like Food Product)

The meat-like food product according to the present invention includes mixing a plant-derived protein and the ingredient (A) with food product materials to prepare a dough of the meat-like food product, and the dough contains 0% by mass or more and 30% by mass or less of an animal-derived protein material.

The dough of the meat-like food product may be prepared by a method usually used. For example, a plant-derived protein, an animal-derived protein material, the ingredient (A), and other food product materials all are placed into a bowl, and are mixed with a mixer or the like. Thus, a dough can be prepared. At this time, the ingredient (A) can be mixed with other raw materials at any timing.

The meat-like food product according to the present invention can be prepared through a forming step of forming the dough of the meat-like food product thus prepared to prepare a formed product, and a heating and cooking step of cooking the formed product by heating.

Specific examples of cooking by heating in the heating and cooking step include baking, boiling, heating with a microwave oven, steaming, heating by steam convection, and frying. Preferred are one or two or more selected from the group consisting of baking, steaming, heating by steam convection, and frying. More preferred are one or two or more selected from the group consisting of baking and heating by steam convection.

The method of producing a meat-like food product according to the present invention may involve a step of storing under freezing or refrigeration after the step of forming the dough of the meat-like food product or before the heating and cooking step. Alternatively, the heating and cooking step may be followed by a step of storing the prepared food product by storing under freezing, refrigeration, or in a retort pouch at normal temperature, and then the food product may be reheated when eaten. Examples of the reheating method include the same methods as those described in the above cooking by heating. Preferred is heating with a microwave oven.

### (Texture Improver for Meat-Like Food Product)

The texture improver for the meat-like food product according to the present invention is applied to a meat-like food product containing a plant-derived protein and 0% by mass or more and 30% by mass or less of an animal-derived protein material, and contains the ingredient (A) as the active ingredient. Details of the meat-like food product, the plant-derived protein, the animal-derived protein material, and the ingredient (A) have been already described in the above sections (Meat-like food product), (Plant-derived protein), (Animal-derived protein material), and (Ingredient (A)), and the description thereof will be omitted.

The texture improver according to the present invention may contain ingredients other than the ingredient (A). If the texture improver contains ingredients other than the ingredient (A), the texture improver can contain a combination of one or two or more of the food product materials listed above, and preferably contains a powdery food product material.

To stably demonstrate the texture improving effect, the content of the ingredient (A) in the texture improver according to the present invention is preferably 40% by mass or more, more preferably 60% by mass or more, still more preferably 80% by mass or more. The upper limit of the content of the ingredient (A) in the texture improver is 100% by mass, and may be 99% by mass or less.

The texture improver according to the present invention, when used, is added to the dough of the meat-like food product. To reduce the stickiness and improve the disentanglement properties, the amount of the texture improver added to the dough is preferably 0.3% by mass or more, more preferably 1.3% by mass or more, still more preferably 2.5% by mass or more, further still more preferably 3.3% by mass or more, most preferably 4.5% by mass or more.

From the same viewpoint as above, the amount of the texture improver added to the dough according to the present invention is preferably 15% by mass or less, more preferably 11% by mass or less.

Here, the improvement in texture of the meat-like food product according to the present invention preferably indicates one or two or more selected from the group consisting of a reduction in stickiness, an improvement in chewability, and an improvement in disentanglement properties, more preferably one or two or more selected from the group consisting of a reduction in stickiness and an improvement in disentanglement properties, still more preferably an improvement in disentanglement properties.

### (Method of Reducing Stickiness of Meat-Like Food Product)

The method of reducing stickiness of the meat-like food product according to the present invention includes adding the ingredient (A) to a dough of the meat-like food product containing a plant-derived protein and 0% by mass or more and 30% by mass or less of an animal-derived protein material. Details of the meat-like food product, the plant-derived protein, the animal-derived protein material, and the ingredient (A) have been already described in the above sections (Meat-like food product), (Plant-derived protein), (Animal-derived protein material), and (Ingredient (A)), and the description thereof will be omitted.

### (Method of Improving Disentanglement Properties of Meat-Like Food Product)

The method of improving disentanglement properties of the meat-like food product according to the present invention includes adding the ingredient (A) to a dough of the meat-like food product containing a plant-derived protein and 0% by mass or more and 30% by mass or less of an animal-derived protein material. Details of the meat-like food product, the plant-derived protein, the animal-derived protein material, and the ingredient (A) have been already described in the above sections (Meat-like food product), (Plant-derived protein), (Animal-derived protein material), and (Ingredient (A)), and the description thereof will be omitted.

### EXAMPLES

Examples of the present invention will now be described, but the gist of the present invention will not be limited to these.

Hereinafter, “%” indicates “% by mass” unless otherwise specified. A dough of the meat-like food product is simply referred to as dough.

Raw materials listed below were mainly used.

### (Starches)

corn starch: available from J-OIL MILLS, Inc., Corn starch Y
high-amylose corn starch: available from J-OIL MILLS, Inc., HS-7 (amylose content: 70% by mass)
tapioca starch: available from J-OIL MILLS, Inc.
potato starch: BP-200, available from J-OIL MILLS, Inc.

### (Plant-Derived Proteins)

soybean protein 1 (small grain): Fujinic Ace 500, available from FUJI OIL CO., LTD.
soybean protein 2 (large grain): Vegitex SHF, available from FUJI OIL CO., LTD.
soybean protein 3 (powder): New Fujipro SEH, available from FUJI OIL CO., LTD.
pea protein: available from Roquette Japan K.K.
wheat protein: gluten meat, available from Saniku Foods Co., Ltd.
boiled chickpea: Salad Club Garbanzo (chickpea), available from Kewpie

### Corporation

### (Others)

dried egg white: available from Kewpie Corporation
oatmeal: Quaker Instant Oatmeal regular, available from Quaker

### Corporation

wheat flour: flour, available from Nissin Foods Inc.
rapeseed oil: Sarasara Canola Oil, available from J-OIL MILLS, Inc.

### (Production Example 1) Preparation of Ingredient (A)

In this example, an ingredient (A) was prepared using an acid-treated starch as a molecular weight-reduced starch.

### (Method of Preparing Acid-Treated High-Amylose Corn Starch)

A high-amylose corn starch was suspended in water to prepare a 35.6%(w/w) slurry, which was heated to 50° C. Under stirring, a 4.25N hydrochloric acid aqueous solution was added to the slurry in an amount of one ninth of the slurry mass to start a reaction. After the 16-hour reaction, the product was neutralized with 3% NaOH, was washed with water, was dehydrated, and was dried to yield an acid-treated high-amylose corn starch.

The peak molecular weight of the resulting acid-treated high-amylose corn starch was measured by the following method. The peak molecular weight was 1.2×10⁴.

(Method of measuring peak molecular weight)

The peak molecular weight was measured using a HPLC unit available from Tosoh Corporation (pump DP-8020, RI detector RS-8021, degasifier SD-8022).
(1) A sample was ground, and a fraction under a sieve having an opening of 0.15 mm according to the JIS-Z8801-1 standard was recovered with the sieve. The recovered fraction was suspended in a mobile phase at 1 mg/mL, and the suspension was heated at 100° C. for 3 minutes to completely dissolve the sample. Filtration was performed using a 0.45-₁.tm filtration filter (available from ADVANTEC Co., LTD., DISMIC-25HP PTFE 0.45 μm), and a filtrate was used as a sample for analysis.
(2) The molecular weight was measured on the following analysis conditions.
   columns: two TSKgel a-M columns (7.8 mmy, 30 cm) (available from Tosoh Corporation)
   flow rate: 0.5 mL/min
   mobile phase: 90%(v/v) dimethyl sulfoxide solution containing 5 mM sodium nitrate
   column temperature: 40° C.
   amount to be analyzed: 0.2 mL
(3) The data from the detector was collected with software (Multi-station GPC-8020 Model II Data Collection ver. 5.70, available from Tosoh Corporation), and the molecular weight peak was calculated.

For the calibration curve, pullulan having a known molecular weight

(Shodex Standard P-82, available from Showa Denko K.K.) was used.

### (Method of Preparing Ingredient (A))

79% by mass of β starch, 20% by mass of the acid-treated high-amylose corn starch prepared by the above method, and 1% by mass of calcium carbonate were sufficiently homogeneously mixed in a bag. Using a twin-screw extruder (available from Kowa Kogyo Inc., KEI-45), the mixture was subjected to a heat treatment under a pressure. The conditions for the treatment are as follows.
feed of raw materials: 450 g/min
water added: 17% by mass
barrel temperatures: 50° C., 70° C., and 100° C. from the raw material inlet to the outlet
outlet temperature: 100 to 110° C.
the number of rotations of the screw: 250 rpm

This heated gelatinized product through the treatment in the extruder was dried at 110° C. to control the moisture content to about 10% by mass.

In the next step, the dried heated gelatinized product was crushed with a desktop cutter mill, and was sieved with sieves according to the JIS-Z8801-1 standard. The sieved heated gelatinized products were mixed in proportions shown in Table 1 to prepare two ingredients (A) as below.

The degree of swelling in cold water of each ingredient (A) was measured by the method described later. That of the form of granular powder 1 was 7.8, and that of the form of granular powder 2 was 10.5.

### (Method of Measuring Degree of Swelling in Cold Water)

(1) Using an aquameter (KENSEI KOGYO Co., Ltd., Model No. MX-50), a sample was dried by heating at 125° C., and the moisture content was measured. From the measured moisture content, the dry mass was calculated.
(2) 1 g (in terms of the dry mass) of the sample was dispersed in 50 mL of water at 25° C., followed by mild stirring for 30 minutes in a thermostat at 25° C. The mixture was centrifuged at 3000 rpm for 10 minutes (centrifuge: available from Hitachi Koki Co., Ltd., Hitachi desktop centrifuge CT6E type; rotor: T4SS swing rotor; adapter: 50TC x 2S adapter) to separate the precipitant layer from the supernatant layer.
(3) The supernatant layer was extracted. The mass of the precipitant layer was measured, and was defined as B (g).
(4) The precipitant layer was dried to solidness (105° C., constant mass), and the mass at this time was defined as C (g).
(5) The value obtained by dividing B by C was defined as a degree of swelling in cold water.

TABLE 1

| | Form of | Form of |
|---|---|---|
| | granular | granular |
| Fraction (% by mass) | powder 1 | powder 2 |
| Under 3.35 mm sieve and on 1.4 mm sieve | 0.2 | |
| Under 1.4 mm sieve and on 1 mm sieve | 13.2 | |
| Under 1 mm sieve and on 0.5 mm sieve | 38.5 | 18.0 |
| Under 0.5 mm sieve and on 0.25 mm sieve | 19.5 | 42.0 |
| Under 0.25 mm sieve and on 0.15 mm sieve | 10.4 | 15.0 |
| Under 0.15 mm sieve and on 0.075 mm sieve | 13.7 | 20.0 |
| Under 0.075 mm sieve and on 0.038 mm sieve | 3.3 | 3.7 |
| Under 0.038 mm sieve | 1.2 | 1.3 |
| Under 3.35 mm sieve and on 0.038 mm sieve | 98.8 | 98.7 |
| Under 0.5 mm sieve and on 0.075 mm sieve | 43.6 | 77.0 |
| Degree of swelling in cold water | 7.8 | 10.5 |

Note)
For example, ″Under 3.35 mm sieve and on 1.4 mm sieve″ means ″under a sieve having an opening of 3.35 mm and on a sieve having an opening of 1.4 mm according to the JIS-Z8801-1 standard″.

### (Test 1)

In this example, the form of granular powder 1 was added as the ingredient (A) to prepare a dough, and the dough was cooked by heating to prepare soy burger patties as the meat-like food product. These were evaluated. Table 2 shows the formulations for each of the soy burger patties.

(Method 1 of preparing soy burger patties)

Soy burger patties were prepared using the formulations shown in Table 2 according to the following procedure.
1. Water for reconstituting a plant-derived protein was added to soybean proteins to reconstitute the soybean proteins with water.
2. The materials described in 1. above and all other raw materials were placed into a bowl, and were sufficiently mixed with a mixer to prepare a dough for soy burger patties of each formulation.
3. The resulting dough in 2. above was formed into formed products each having a weight of 80 g, and each surface of the formed products was baked on a medium flame for one minute with a frying pan. Subsequently, the formed products were baked at 180° C. and a relative humidity of 80% for 8 minutes in a steam convection oven to prepare soy burger patties.
   (Sensory evaluation)

The soy burger patties immediately after baking were eaten to evaluate the soy burger patties for the presence/absence of stickiness and the disentanglement properties (disentanglement properties when chewed).

Each item for evaluation was rated by discussion by 5 specialized panelists, and the rating of 3 or more points was defined as acceptable. The ratings of these items are shown below. The results of evaluation in Examples are shown in Table 2.

(Absence of stickiness (absence of stickiness when chewed))
5: Non-sticky at all
4: Hardly sticky
3: Slightly sticky but at an acceptable level
2: Considerably sticky
1: Very sticky

### (Chewability)

5: Very chewable when chewed
4: Considerably chewable when chewed
3: Chewable when chewed
2: Slightly chewy when chewed
1: Chewy when chewed
   (Disentanglement properties (disentanglement properties when chewed))
5: Immediately disentangled when chewed
4: Almost immediately disentangled when chewed
3: Disentangled for a while after chewed
2: Not disentangled much even for a while after chewed
1: Hardly disentangled even for a while after chewed

TABLE 2

| | Control Example | | Example 1-1 | | Example 1-2 | |
|---|---|---|---|---|---|---|
| | parts by | % by | parts by | % by | parts by | % by |
| Raw materials | mass | mass | mass | mass | mass | mass |
| Soybean protein 1 | 9 | 8.1% | 9 | 7.8% | 9 | 8.3% |
| Soybean protein 2 | 9 | 8.1% | 9 | 7.8% | 9 | 8.3% |
| Water for reconstituting | 36 | 32.5% | 36 | 31.4% | 36 | 33.1% |
| plant-derived protein | | | | | | |
| Dried shiitake mushroom | 4 | 3.6% | 4 | 3.5% | 4 | 3.7% |
| (reconstituted with water) | | | | | | |
| Potato (mashed) | 11 | 9.9% | 11 | 9.6% | 11 | 10.1% |
| Onion (sauteed) | 20 | 18.1% | 20 | 17.4% | 20 | 18.4% |
| Soybean protein 3 | 6 | 5.4% | 6 | 5.2% | 6 | 5.5% |
| Tapioca starch | 3 | 2.7% | 3 | 2.6% | 3 | 2.8% |
| Water | 6 | 5.4% | 6 | 5.2% | | |
| Miso | 2.3 | 2.1% | 2.3 | 2.0% | 2.3 | 2.1% |
| Soy sauce | 3.5 | 3.2% | 3.5 | 3.0% | 3.5 | 3.2% |
| Salt | 0.5 | 0.5% | 0.5 | 0.4% | 0.4 | 0.4% |
| Spice | 0.4 | 0.4% | 0.4 | 0.3% | 0.4 | 0.4% |
| (A) Form of granular | | 0.0% | 4 | 3.5% | 4 | 3.7% |
| powder 1 | | | | | | |
| Total | 110.7 | 100% | 114.7 | 100% | 108.6 | 100% |

| | | | |
|---|---|---|---|
| (A)/in dough (% by mass) | | 3.5% | 3.7% |
| Animal-derived protein/ | 0% | 0% | 0% |
| in dough (% by mass) | | | |

Sensory evaluation (discussion by 5 panelists)

| | | | |
|---|---|---|---|
| Absence of stickiness | 1 | 4 | 4 |
| Chewability | 1 | 4 | 4 |
| Disentanglement properties | 1 | 4 | 5 |

As shown in Table 2, the soy burger patties in Control Example were considerably sticky, chewy, and hardly disentangled when chewed while having a homogenous texture like a boiled fish paste. In contrast, the soy burger patties in Examples 1-1 and 1-2 containing the form of granular powder 1 as the ingredient (A) were preferred because these were hardly sticky, chewable, and immediately disentangled when chewed. The soy burger patties containing 3.7% by mass of the ingredient (A) in the dough had disentanglement properties more excellent than those containing 3.5% by mass of the ingredient (A) in the dough.

### (Test 2)

The formulations of the soy burger patties in this example are shown, in which besides the dried soybean proteins, boiled chickpea was used as a plant-derived protein, and the form of granular powder 1 was added as the ingredient (A). The sensory evaluation was performed by the same method as in Test 1, and the results of evaluation are collectively shown in Table 3.

(Method 2 of preparing soy burger patties)

Soy burger patties were prepared using each of the formulations shown in Table 3 according to the following procedure.
1. Water for reconstituting a plant-derived protein was added to soybean proteins to reconstitute the soybean proteins with water.
2. Chickpea, oatmeal, water, rapeseed oil, and potato starch were processed with a food processor until these came together.
3. The materials described in 1 and 2 above and all other raw materials were placed into a bowl, and were sufficiently mixed with a mixer to prepare a dough for soy burger patties.
4. The resulting dough in 2. above was formed into formed products each having a weight of 80 g, and each surface of the formed products was baked on a medium flame for one minute with a frying pan. Subsequently, the formed products were baked at 180° C. and a relative humidity of 80% for 8 minutes in a steam convection oven to prepare soy burger patties.

TABLE 3

| | Control Example 2 | | Example 2 | |
|---|---|---|---|---|
| | parts by | % by | parts by | % by |
| Raw materials | mass | mass | mass | mass |
| Soybean protein 1 | 50 | 9.8% | 50 | 9.8% |
| Soybean protein 2 | 50 | 9.8% | 50 | 9.8% |
| Water for reconstituting | 180 | 35.2% | 180 | 35.2% |
| plant-derived protein | | | | |
| Chopped onion (fresh) | 85 | 16.6% | 85 | 16.6% |
| Sliced mushroom | 15 | 2.9% | 15 | 2.9% |
| Chickpea (boiled) | 50 | 9.8% | 50 | 9.8% |
| Oatmeal | 21 | 4.1% | 21 | 4.1% |
| Water | 14 | 2.7% | 14 | 2.7% |
| Rapeseed oil | 21 | 4.1% | 21 | 4.1% |
| Potato starch | 14 | 2.7% | 4 | 0.8% |
| Seasoning | 12 | 2.3% | 12 | 2.3% |
| (A) Form of granular powder 1 | | | 10 | 2.0% |
| Total | 512 | 100% | 512 | 100% |

| | | |
|---|---|---|
| (A)/in dough (% by mass) | | 2.0% |
| Animal-derived protein/in dough | 0% | 0% |
| (% by mass) | | |

Sensory evaluation (discussion by 5 panelists)

| | | |
|---|---|---|
| Absence of stickiness | 2 | 4 |
| Chewability | 3 | 4 |
| Disentanglement properties | 2 | 4 |

The results in Table 3 show that the soy burger patties containing plant-derived proteins and a predetermined amount of the form of granular powder 1 as the ingredient (A) were not sticky, were chewable, and had excellent disentanglement properties.

### (Test 3)

In this example, soy burger patties were prepared by the same method as in Test 1 except that the compositions shown in Table 4 containing dried egg white as a binder were used. The sensory evaluation was performed by the same method as in Test 1, and the results of evaluation are collectively shown in Table 4.

TABLE 4

| | Control | | | |
|---|---|---|---|---|
| | Example 3 | | Example 3 | |
| | parts by | % by | parts by | % by |
| Raw materials | mass | mass | mass | mass |
| Soybean protein 1 | 25 | 11.6% | 25 | 10.8% |
| Soybean protein 2 | 25 | 11.6% | 25 | 10.8% |
| Water for reconstituting | 100 | 46.4% | 100 | 43.3% |
| plant-derived protein | | | | |
| Stock | 3 | 1.4% | 3 | 1.3% |
| Spice | 6 | 2.8% | 6 | 2.6% |
| Honey | 5 | 2.3% | 5 | 2.2% |
| Sauteed onion | 30 | 13.9% | 30 | 13.0% |
| Wheat flour | 9 | 4.2% | 9 | 3.9% |
| Dried egg white | 7 | 3.2% | 7 | 3.0% |
| Rapeseed oil | 5 | 2.3% | 5 | 2.2% |
| Salt | 0.5 | 0.2% | 0.5 | 0.2% |
| (A) Form of granular powder 1 | — | — | 2.2 | 0.9% |
| Rapeseed oil | — | — | 8.7 | 3.8% |
| Water | — | — | 4.3 | 1.9% |
| Subtotal | 215.5 | 100% | 230.7 | 100% |
| (A)/in dough (% by mass) | — | — | | 0.9% |

| | | |
|---|---|---|
| Animal-derived protein/in dough | 3.2% | 3.0% |
| (% by mass) | | |

Sensory evaluation (discussion by 5 panelists)

| | | |
|---|---|---|
| Absence of stickiness | 2 | 4 |
| Chewability | 3 | 4 |
| Disentanglement properties | 2 | 4 |

The results in Table 4 show that the soy burger patties containing plant-derived proteins and a predetermined amount of the form of granular powder 1 as the ingredient (A) were not sticky, were chewable, and had excellent disentanglement properties. Compared to Control Example, the effects of the present invention were demonstrated even in the case where dried egg white was contained as an animal-derived protein.

### (Test 4)

In this example, soy burger patty formulations containing the form of granular powder 1 or 2 as the ingredient (A) were prepared. As the plant-derived protein, pea protein and wheat protein were also evaluated.

Soy burger patties were prepared by the same method as in Test 1 except that the compositions shown in Table 5 were used. The sensory evaluation was also performed by the same method as in Test 1. The results of evaluation are shown in Table 5.

TABLE 5

| | Control Example 4 | | Example 4-1 | | Example 4-2 | | Example 4-3 | | Example 4-4 | | Example 4-5 | |
|---|---|---|---|---|---|---|---|---|---|---|---|---|
| | parts by | % by | parts by | % by | parts by | % by | parts by | % by | parts by | % by | parts by | % by |
| Raw materials | mass | mass | mass | mass | mass | mass | mass | mass | mass | mass | mass | mass |
| Soybean protein 1 | 10.8 | 10.9% | 10.8 | 10.2% | 10.8 | 10.5% | 10.8 | 10.5% | | | | |
| Soybean protein 2 | 10.8 | 10.9% | 10.8 | 10.2% | 10.8 | 10.5% | 10.8 | 10.5% | | | | |
| Pea protein | | | | | | | | | 18 | 17.5% | | |
| Water for reconstituting | 32.4 | 32.8% | 32.4 | 30.7% | 32.4 | 31.6% | 32.4 | 31.6% | 36 | 35.1% | | |
| plant-derived protein | | | | | | | | | | | | |
| Wheat protein | | | | | | | | | | | 54 | 52.6% |
| Dried shiitake mushroom | 4 | 4.1% | 4 | 3.8% | 4 | 3.9% | 4 | 3.9% | 4 | 3.9% | 4 | 3.9% |
| (reconstituted with water) | | | | | | | | | | | | |
| Potato (mashed) | 11 | 11.1% | 11 | 10.4% | 11 | 10.7% | 11 | 10.7% | 11 | 10.7% | 11 | 10.7% |
| Onion (sauteed) | 20 | 20.3% | 20 | 18.9% | 20 | 19.5% | 20 | 19.5% | 20 | 19.5% | 20 | 19.5% |
| Wheat flour | 3 | 3.0% | 3 | 2.8% | 3 | 2.9% | 3 | 2.9% | 3 | 2.9% | 3 | 2.9% |
| Miso | 2.3 | 2.3% | 2.3 | 2.2% | 2.3 | 2.2% | 2.3 | 2.2% | 2.3 | 2.2% | 2.3 | 2.2% |
| Soy sauce | 3.5 | 3.5% | 3.5 | 3.3% | 3.5 | 3.4% | 3.5 | 3.4% | 3.5 | 3.4% | 3.5 | 3.4% |
| Salt | 0.5 | 0.5% | 0.5 | 0.5% | 0.4 | 0.4% | 0.4 | 0.4% | 0.4 | 0.4% | 0.4 | 0.4% |
| Spice | 0.4 | 0.4% | 0.4 | 0.4% | 0.4 | 0.4% | 0.4 | 0.4% | 0.4 | 0.4% | 0.4 | 0.4% |
| (A) Form of granular | | | 7 | 6.6% | 4 | 3.9% | | | 4 | 3.9% | 4 | 3.9% |
| powder 1 | | | | | | | | | | | | |
| (A) Form of granular | | | | | | | 4 | 3.9% | | | | |
| powder 2 | | | | | | | | | | | | |
| Total | 98.7 | 100% | 105.7 | 100% | 102.6 | 100% | 102.6 | 100% | 102.6 | 100% | 102.6 | 100% |

| | | | | | | |
|---|---|---|---|---|---|---|
| (A)/in dough (% by mass) | — | 6.6% | 3.9% | 3.9% | 3.9% | 3.9% |
| Animal-derived protein/ | 0% | 0% | 0% | 0% | 0% | 0% |
| in dough (% by mass) | | | | | | |

Sensory evaluation (discussion by 5 panelists)

| | | | | | | |
|---|---|---|---|---|---|---|
| Absence of stickiness | 2 | 5 | 4 | 5 | 4 | 4 |
| Chewability | 2 | 4 | 4 | 5 | 4 | 4 |
| Disentanglement properties | 2 | 5 | 5 | 4 | 4 | 3 |

The results in Table 5 show that the soy burger patties containing the plant-derived proteins and a predetermined amount of the form of granular powder 1 or 2 as the ingredient (A) had reduced stickiness, high chewability, and excellent disentanglement properties.

From the viewpoint of a reduction in stickiness and an improvement in chewability, these properties were more excellent in the cases where the dough contained the form of granular powder 2 as the ingredient (A) than in the case where the dough contained the form of granular powder 1. From the viewpoint of an improvement in disentanglement properties, the properties were more excellent in the case where the dough contained the form of granular powder 1 than in the cases where the dough contained the form of granular powder 2.

With respect to the type of plant-derived protein which improves disentanglement properties, the most excellent was soybean protein, pea protein second, and wheat protein third.

Comparison from Tables 2 to 5 shows that the doughs each containing 0.9% by mass or more and 6.6% by mass or less of the form of granular powder 1 as the ingredient (A) provided a texture more excellent than those in Control Examples.

From the viewpoint of the absence of stickiness, the cases where the dough contained 0.9% by mass or more and 6.6% by mass or less of the ingredient (A) were favorable, and the cases where the dough contained 3.9% by mass or more and 6.6% by mass or less of the ingredient (A) were more favorable. From the viewpoint of an improvement in disentanglement properties, the cases where the dough contained 0.9% by mass or more and 6.6% by mass or less of the ingredient (A) were favorable, and the cases where the dough contained 3.7% by mass or more and 6.6% by mass or less of the ingredient (A) were more favorable.

### (Test 5)

In this example, soybean dumplings containing the form of granular powder 1 or 2 as the ingredient (A) were prepared.

Soybean dumplings were prepared using each of the formulations shown in Table 6 according to the following procedure. In Test 5, besides the above raw materials, the following raw materials were additionally used.
soybean protein 4: Apex 950, available from FUJI OIL CO., LTD.
shortening 1: Fasie, available from J-OIL MILLS, Inc.
sesame oil: AJINOMOTO Gomayuzukino Gomayu, available from J-OIL MILLS, Inc.
stock: Maggi stock additive-free, available from Nestle Japan Limited
1. All the raw materials shown in Table 6 were homogeneously mixed with a ken mix mixer (available from AICOHSHA MFG. CO., LTD.) to prepare fillings for dumplings.
2. Each of the fillings in 1 above was divided into portions each having an amount of 20 g and wrapped with a commercially available wrapper (available from MORANBONG limited, Large Gyoza Wrapper.
3. A frying pan was heated for 30 seconds with an IH heater, and was oiled. Nine dumplings in 2 above were placed into the frying pan, and 100 ml of water was added. The frying pan was covered with a lid to steam bake the dumplings over high heat for 6 minutes. Further, the lid was removed, followed by heating for 1 minute. Thus, baked dumplings were prepared.
4. The dumplings prepared in 3 above were wrapped with a food wrap, and were stored at room temperature for 1 hour. Thereafter, the dumplings were reheated with a 500 W microwave oven for 30 seconds. These were eaten for evaluation.

TABLE 6

| | Control | Example | Example |
|---|---|---|---|
| Raw materials (% by mass) | Example 5 | 5-1 | 5-2 |
| Soybean protein 1 | 6.7% | 6.7% | 6.7% |
| Soybean protein 2 | 12.5% | 12.4% | 12.4% |
| Soybean protein 4 | 11.2% | 11.1% | 11.1% |
| Pepper | 0.1% | 0.1% | 0.1% |
| Dietary salt | 0.4% | 0.4% | 0.4% |
| Garlic paste | 0.7% | 0.7% | 0.7% |
| Ginger paste | 0.7% | 0.7% | 0.7% |
| Dried egg white | 2.0% | 2.0% | 2.0% |
| Granulated sugar | 0.2% | 0.2% | 0.2% |
| Soy sauce | 4.2% | 4.2% | 4.2% |
| Shortening 1 | 17.0% | 16.8% | 16.8% |
| Sesame oil | 0.3% | 0.3% | 0.3% |
| Stock | 0.4% | 0.4% | 0.4% |
| Mirin | 4.2% | 4.2% | 4.2% |
| Scallion | 15.5% | 15.3% | 15.3% |
| Cabbage | 20.5% | 20.3% | 20.3% |
| Rapeseed oil | 1.2% | 1.2% | 1.2% |
| Water | 2.0% | 2.0% | 2.0% |
| (A) Form of granular powder 1 | | 1.0% | |
| (A) Form of granular powder 2 | | | 1.0% |
| Total | 100% | 100% | 100% |
| (A)/in dough (% by mass) | 0% | 1.0% | 1.0% |
| Animal-derived protein/in dough | 2.0% | 2.0% | 2.0% |
| (% by mass) | | | |

Compared to the soybean dumplings in Control Example 5, the soybean dumplings (Examples 5-1 and 5-2) prepared by adding the form of granular powder 1 or 2 as the ingredient (A) were non-sticky, had excellent chewability and excellent disentanglement properties, and all were preferred. In contrast, the soybean dumplings in Control Example 5 were sticky, and had reduced chewability and disentanglement properties.

(Production Example 1 of texture improver)

50 parts by mass of corn starch and 50 parts by mass of the form of granular powder 2 as the ingredient (A) were mixed to prepare a texture improver for the meat-like food product according to the present invention.

(Production Example 1 of meat-like food product)

10 parts by mass of the soybean protein 1 reconstituted with 20 parts by mass of water, 10 parts by mass of soybean protein 2 reconstituted with 20 parts by mass of water, 20 parts by mass of minced pork meat, 4 parts by mass of the form of granular powder 1 as the ingredient (A), 2 parts by mass of potato starch, 10 parts by mass of sauteed onion, 0.5 parts by mass of salt, 0.5 parts by mass of spice, and 3 parts by mass of soy sauce were sufficiently mixed with a mixer to prepare a dough of a meat-like food product. The dough was formed into oval-shaped doughs each having an amount of 50 parts by mass. These were wrapped with a food product film, were placed into a zipped plastic bag, and were stored under freezing at −20° C. for 3 days.

The frozen doughs were thawed in a 4° C. refrigerator for about 8 hours, and each surface thereof was baked for 1 minute with a heated frying pan. Thereafter, the doughs were baked in a steam convection oven at a relative humidity of 80% and 180° C. for 7 minutes to prepare hamburgers containing soybean protein. The resulting hamburgers had reduced stickiness, and had excellent chewability and disentanglement properties.

This application claims priority to Japanese Patent Application No. 2019-235248 filed in Japan on Dec. 25, 2019, the entire contents of which are hereby incorporated.

1. A method of producing a meat-like food product, comprising adding a plant-derived protein and an ingredient (A) to food product materials to prepare a dough,
wherein the dough contains 0% by mass or more and 30% by mass or less of an animal-derived protein material, and
the ingredient (A) is a form of granular powder satisfying the conditions (1) to (4):
(1) the form of granular powder has a starch content of 75% by mass or more,
(2) the form of granular powder contains 3% by mass or more and 45% by mass or less of a molecular weight-reduced starch of a starch having an amylose content of 5% by mass or more, the molecular weight-reduced starch having a peak molecular weight of 3×10³ or more and 5×10⁴ or less,
(3) the form of granular powder has a degree of swelling in cold water at 25° C. of 5 or more and 20 or less, and
(4) a content of matters under a sieve having an opening of 3.35 mm and on a sieve having an opening of 0.038 mm is 50% by mass or more and 100% by mass or less.

2. The production method according to claim 1, wherein the amount of the ingredient (A) added to the dough is 0.3% by mass or more and 10% by mass or less.

3. The production method according to claim 1 or 2,
wherein the plant-derived protein is derived from one or two or more selected from the group consisting of soybean, pea, and wheat.

4. The production method according to claim 1, wherein the plant-derived protein is a separated and refined protein.

5. The production method according to claim 1, wherein the dough contains 0% by mass of the animal-derived protein material.

6. The production method according to claim 1, wherein the ingredient (A) has a content of matters under a sieve having an opening of 0.5 mm and on a sieve having an opening of 0.075 mm of 25% by mass or more and 100% by mass or less.

7. The production method according to claim 1, further comprising cooking the dough by heating.

8. A dough of a meat-like food product comprising a plant-derived protein, food product materials, and an ingredient (A), wherein the dough contains 0% by mass or more and 30% by mass or less of an animal-derived protein material, and
the ingredient (A) is a form of granular powder satisfying the conditions (1) to (4):
(1) the form of granular powder has a starch content of 75% by mass or more,
(2) the form of granular powder contains 3% by mass or more and 45% by mass or less of a molecular weight-reduced starch of a starch having an amylose content of 5% by mass or more, the molecular weight-reduced starch having a peak molecular weight of 3×10³ or more and 5×10⁴ or less,
(3) the form of granular powder has a degree of swelling in cold water at 25° C. of 5 or more and 20 or less, and
(4) a content of matters under a sieve having an opening of 3.35 mm and on a sieve having an opening of 0.038 mm is 50% by mass or more and 100% by mass or less.

9. A texture improver for a meat-like food product, comprising an ingredient (A) as an active ingredient,
wherein a dough of the meat-like food product contains a plant-derived protein, and contains 0% by mass or more and 30% by mass or less of an animal-derived protein material, and
the ingredient (A) is a form of granular powder satisfying the conditions (1) to (4):
(1) the form of granular powder has a starch content of 75% by mass or more,
(2) the form of granular powder contains 3% by mass or more and 45% by mass or less of a molecular weight-reduced starch of a starch having an amylose content of 5% by mass or more, the molecular weight-reduced starch having a peak molecular weight of 3×10³ or more and 5×10⁴ or less,
(3) the form of granular powder has a degree of swelling in cold water at 25° C. of 5 or more and 20 or less, and
(4) a content of matters under a sieve having an opening of 3.35 mm and on a sieve having an opening of 0.038 mm is 50% by mass or more and 100% by mass or less.

10. A method of reducing stickiness of a meat-like food product prepared by cooking a dough containing a plant-derived protein by heating, wherein the dough contains 0% by mass or more and 30% by mass or less of an animal-derived protein material,
the method comprising adding an ingredient (A) to the dough, wherein the ingredient (A) is a form of granular powder satisfying the conditions (1) to (4):
(1) the form of granular powder has a starch content of 75% by mass or more,
(2) the form of granular powder contains 3% by mass or more and 45% by mass or less of a molecular weight-reduced starch of a starch having an amylose content of 5% by mass or more, the molecular weight-reduced starch having a peak molecular weight of 3×10³ or more and 5×10⁴ or less,
(3) the form of granular powder has a degree of swelling in cold water at 25° C. of 5 or more and 20 or less, and
(4) a content of matters under a sieve having an opening of 3.35 mm and on a sieve having an opening of 0.038 mm is 50% by mass or more and 100% by mass or less.

11. A method of improving disentanglement properties of a meat-like food product prepared by cooking a dough containing a plant-derived protein by heating, wherein the dough contains 0% by mass or more and 30% by mass or less of an animal-derived protein material,
the method comprising adding an ingredient (A) to the dough, wherein the ingredient (A) is a form of granular powder satisfying the conditions (1) to (4):
(1) the form of granular powder has a starch content of 75% by mass or more,
(2) the form of granular powder contains 3% by mass or more and 45% by mass or less of a molecular weight-reduced starch of a starch having an amylose content of 5% by mass or more, the molecular weight-reduced starch having a peak molecular weight of 3×10³ or more and 5×10⁴ or less,
(3) the form of granular powder has a degree of swelling in cold water at 25° C. of 5 or more and 20 or less, and
(4) a content of matters under a sieve having an opening of 3.35 mm and on a sieve having an opening of 0.038 mm is 50% by mass or more and 100% by mass or less.
